(19) United States
(12) Patent Application Publication
(10) Pub. No.: US 2025/0048266 A1
(43) Pub. Date: Feb. 6, 2025

(54) REQUESTED SYNCHRONIZATION SIGNAL BLOCKS

(71) Applicant: QUALCOMM Incorporated, San Diego, CA (US)

(72) Inventors: Marwen ZORGUI, San Diego, CA (US); Ahmed Attia ABOTABL, San Diego, CA (US); Konstantinos DIMOU, New York, NY (US); Ahmed ELSHAFIE, San Diego, CA (US)

(21) Appl. No.: 18/362,668

(22) Filed: Jul. 31, 2023

(51) Int. Cl. H04W 52/02; H04W 56/00; H04W 76/20

(52) U.S. Cl. CPC H04W 52/0235; H04W 56/0015; H04W 76/20

(57) ABSTRACT

Various aspects of the present disclosure generally relate to wireless communication. In some aspects, a user equipment (UE) may transmit a cell wake-up signal (WUS) that indicates a request for a synchronization signal block (SSB). The UE may receive the SSB via a resource that is based at least in part on an offset from a reference resource. Numerous other aspects are described.

### FIELD OF THE DISCLOSURE

Aspects of the present disclosure generally relate to wireless communication and to techniques and apparatuses for requested synchronization signal blocks.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include transmitting a cell wake-up signal (WUS) that indicates a request for a synchronization signal block (SSB). The method may include receiving the SSB via a resource that is based at least in part on an offset from a reference resource.

Some aspects described herein relate to a method of wireless communication performed by a network node. The method may include receiving a cell WUS that indicates a request for an SSB. The method may include transmitting the SSB via a resource that is based at least in part on an offset from a reference resource.

Some aspects described herein relate to a UE for wireless communication. The UE may include one or more memories and one or more processors coupled to the one or more memories. The one or more processors may be configured to transmit a cell WUS that indicates a request for an SSB. The one or more processors may be configured to receive the SSB via a resource that is based at least in part on an offset from a reference resource.

Some aspects described herein relate to a network node for wireless communication. The network node may include one or more memories and one or more processors coupled to the one or more memories. The one or more processors may be configured to receive a cell WUS that indicates a request for an SSB. The one or more processors may be configured to transmit the SSB via a resource that is based at least in part on an offset from a reference resource.

Some aspects described herein relate to a non-transitory computer-readable medium that stores a set of instructions for wireless communication by a UE. The set of instructions, when executed by one or more processors of the UE, may cause the UE to transmit a cell WUS that indicates a request for an SSB. The set of instructions, when executed by one or more processors of the UE, may cause the UE to receive the SSB via a resource that is based at least in part on an offset from a reference resource.

Some aspects described herein relate to a non-transitory computer-readable medium that stores a set of instructions for wireless communication by a network node. The set of instructions, when executed by one or more processors of the network node, may cause the network node to receive a cell WUS that indicates a request for an SSB. The set of instructions, when executed by one or more processors of the network node, may cause the network node to transmit the SSB via a resource that is based at least in part on an offset from a reference resource.

Some aspects described herein relate to an apparatus for wireless communication. The apparatus may include means for transmitting a cell WUS that indicates a request for an SSB. The apparatus may include means for receiving the SSB via a resource that is based at least in part on an offset from a reference resource.

Some aspects described herein relate to an apparatus for wireless communication. The apparatus may include means for receiving a cell WUS that indicates a request for an SSB. The apparatus may include means for transmitting the SSB via a resource that is based at least in part on an offset from a reference resource.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of a network energy saving mode, in accordance with the present disclosure.

FIG. 5 is a diagram of an example associated with requested synchronization signal blocks (SSBs), in accordance with the present disclosure.

FIG. 6 is a diagram illustrating an example of a network energy saving mode, in accordance with the present disclosure.

FIG. 7 is a diagram illustrating an example of a network energy saving mode, in accordance with the present disclosure.

FIG. 8 is a diagram illustrating an example of a network energy saving mode, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

In some networks, a network node may conserve power resources based at least in part on initiating an energy saving mode, such as a power saving mode, a needs-based communication mode, and/or a discontinuous reception mode, among other examples. The network node may initiate the energy saving mode (e.g., a sleep mode) based at least in part on traffic conditions. For example, the network node may enter the energy saving mode based at least in part on an amount of traffic and/or a periodicity of traffic satisfying a threshold, among other examples.

The network node may wake up periodically to transmit broadcast signals and/or channels, such as a synchronization signal block (SSB) and/or system information (e.g., a master information block (MIB) or a system information block (SIB), among other examples). Additionally, or alternatively, the network node may wake up periodically to monitor physical random access channel (PRACH) occasions for possible random access channel (RACH) communications or small data transmissions (SDTs) from a user equipment (UE).

Periodic transmission and monitoring may be performed by initiating an active mode, which may cause network power consumption without necessarily providing useful services. In some networks, if the network node knows that there are no connected UEs or that there is a light traffic load in a supported cell, the network node may cease or increase a periodicity of periodic transmissions and/or periodic monitoring to improve network power savings. However, the network node may be unaware of UEs requesting to initiate a connected state or perform an SDT, which would in turn request that the network node transition to an active state. In these cases, UEs may proactively wake up the network node by sending a physical layer signal (e.g., PRACH or a scheduling request (SR)).

In some networks, a UE may transmit a wake-up signal (WUS) to request that a network node wake up so that the UE can communicate with the network node. In some examples, the UE may transmit the WUS via a PRACH, a physical uplink control channel (PUCCH), or a dedicated signal or channel, among other examples.

Various aspects relate generally to WUSs used to request SSBs. Some aspects more specifically relate to SSBs (e.g., on-demand SSBs) received using a resource that is offset from a reference resource based at least in part on transmitting a WUS that indicates a request for an SSB. In some examples, a network node may transmit the SSB using a resource (e.g., in time and frequency) that is based at least in part on a configured time and frequency. For example, a timing of the resource may be based at least in part on an offset from a beginning of an active cycle during which a UE transmitted the WUS.

In some aspects, the network node may transmit the SSB using a resource that is offset (e.g., in time and/or frequency) from a legacy SSB resource. The legacy SSB may include a full SSB (e.g., including a primary synchronization signal (PSS), a secondary synchronization signal (SSS), and a physical broadcast channel (PBCH)) or a light SSB (e.g., excluding at least one symbol or having a reduced frequency band relative to the full SSB).

In some aspects, the network node may transmit the SSB using a resource that is offset from a cell WUS occasion used to transmit the WUS. For example, the SSB may occupy a resource that is offset in time and/or frequency from a resource allocated for transmission of the WUS. In this case, a latency between transmitting the WUS and receiving the SSB may be reduced, such that the UE may achieve synchronization with the network node more quickly that in some other procedures.

In some aspects, the network node may transmit the SSB using the resource with an offset and/or a reference resource that are configured by the network or requested by the UE. Based at least in part on using an offset and/or reference resource that is configured by the network node, no additional signaling may be needed while the network node is in a power saving mode. Based at least in part on using an offset and/or a reference resource that is requested by the UE, the UE may indicate a selection of candidate configurations (e.g., as described herein) that satisfy a need for the SSB (e.g., with reduced latency or with reduced overhead, among other examples).

In some aspects, the network node may transmit the SSB with a power level (e.g., associated with a transmission power relative to a baseline transmission power, such as a power level for transmission of an SSS, PBCH, and/or PBCH demodulation reference signal (DMRS) (β-PSS)) that is configured by the network node or broadcast to the UE (e.g., in a SIB). In some aspects, the power level may be indicated implicitly using an offset from a β-PSS of a legacy SSB (e.g., a full SSB or a light SSB that is not requested by the UE).

Particular aspects of the subject matter described in this disclosure can be implemented to realize one or more of the following potential advantages. In some examples, by using a resource for transmission of the SSB that is offset from a reference resource (e.g., with the reference resource known to the UE and the network node), the described techniques can be used to support synchronization of selection of the resource by the UE and the network node for the SSB. In this way, the UE may request and receive the SSB with reduced latency and/or with reduced overhead that may have otherwise been used to schedule the resource explicitly. Additionally, or alternatively, the UE may improve a likelihood of receiving the SSB based at least in part on being synchronized with the network node for selection of the resource.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

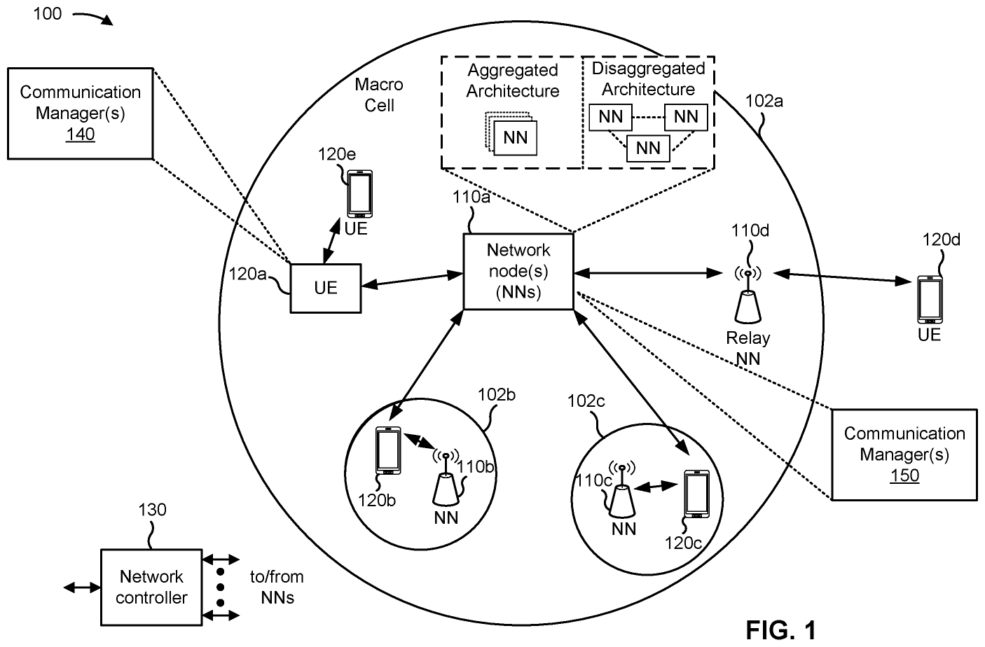

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and May operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHZ-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may transmit a cell WUS that indicates a request for an SSB; and receive the SSB via a resource that is based at least in part on an offset from a reference resource. Additionally, or alternatively, the communication manager 140 may perform one or more other operations described herein.

In some aspects, the network node 110 may include a communication manager 150. As described in more detail elsewhere herein, the communication manager 150 may receive a cell WUS that indicates a request for an SSB; and transmit the SSB via a resource that is based at least in part on an offset from a reference resource. Additionally, or alternatively, the communication manager 150 may perform one or more other operations described herein.

As indicated above, FIG. 1 is provided as an example. Other examples may differ from what is described with regard to FIG. 1.

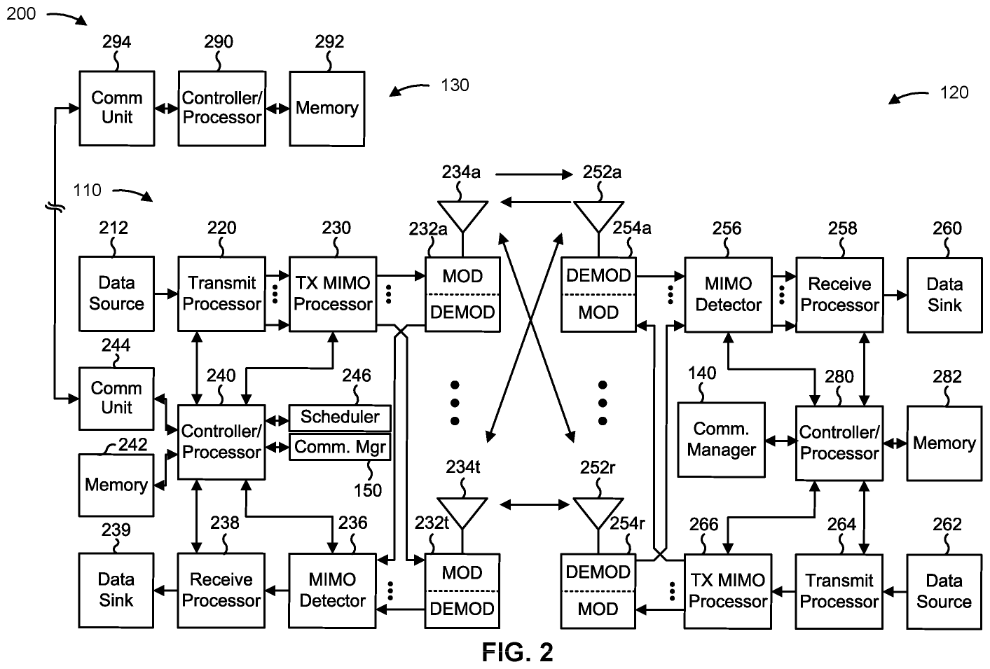

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal DMRS) and synchronization signals (for example, a PSS or an SSS). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

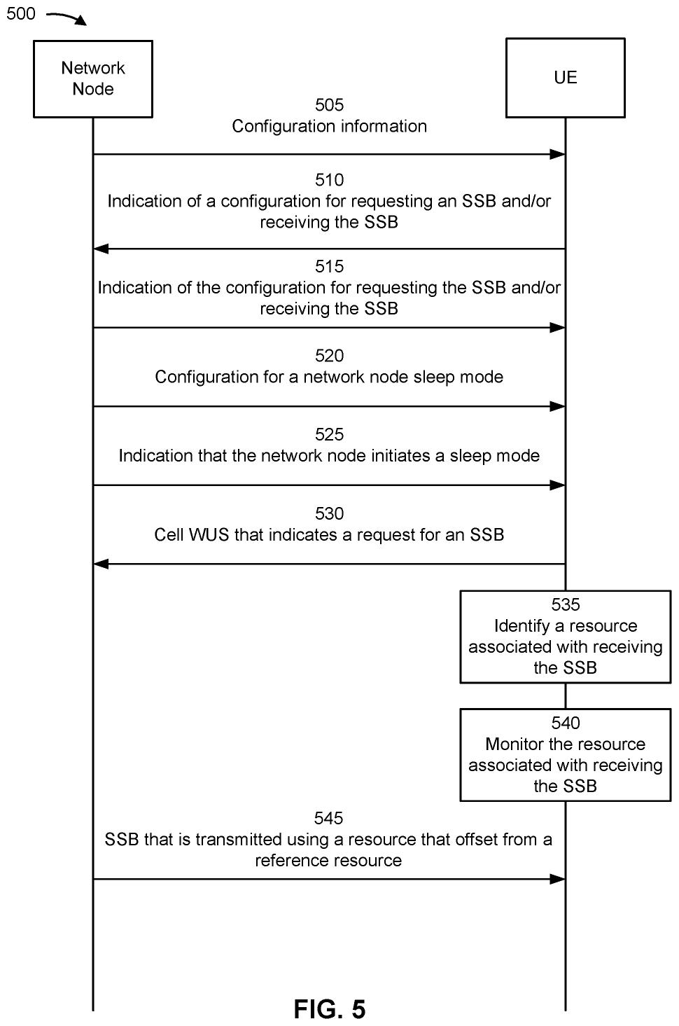

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 5-12).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 5-12).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

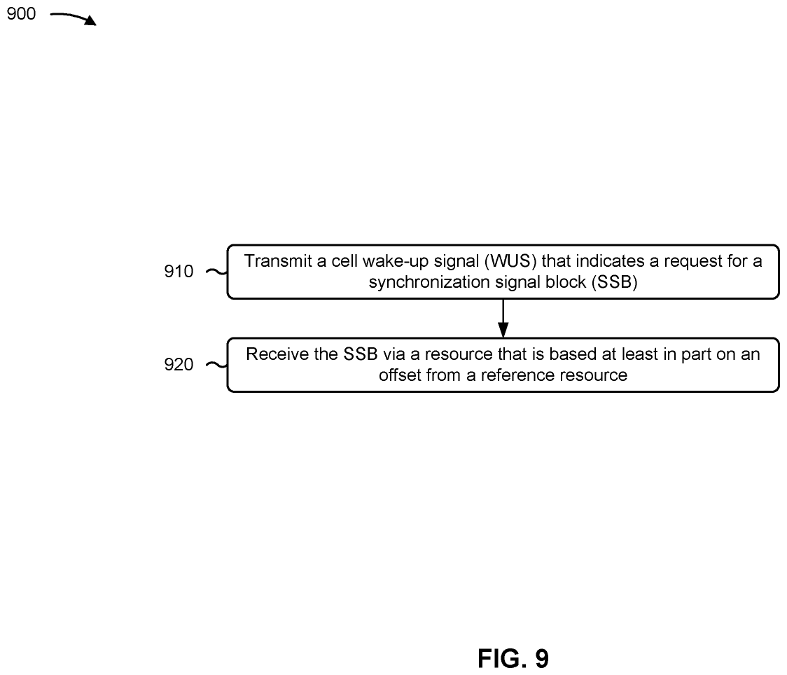

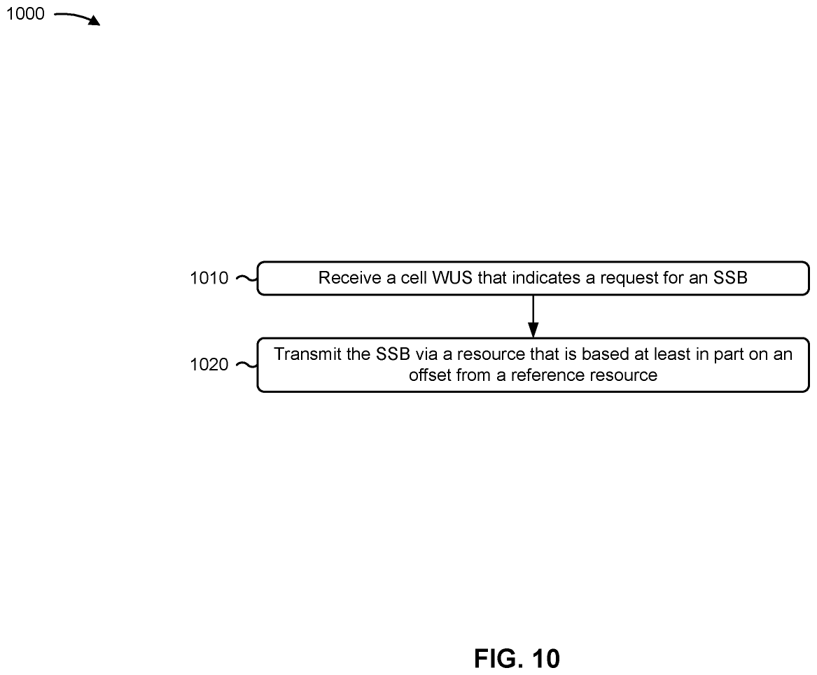

The controller/processor 240 of the network node 110, the controller/processor 280 of the UE 120, or any other component(s) of FIG. 2 may perform one or more techniques associated with requested SSBs, as described in more detail elsewhere herein. For example, the controller/processor 240 of the network node 110, the controller/processor 280 of the UE 120, or any other component(s) (or combinations of components) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for transmitting a cell WUS that indicates a request for an SSB; and/or means for receiving the SSB via a resource that is based at least in part on an offset from a reference resource. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a cell WUS that indicates a request for an SSB; and/or means for transmitting the SSB via a resource that is based at least in part on an offset from a reference resource. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

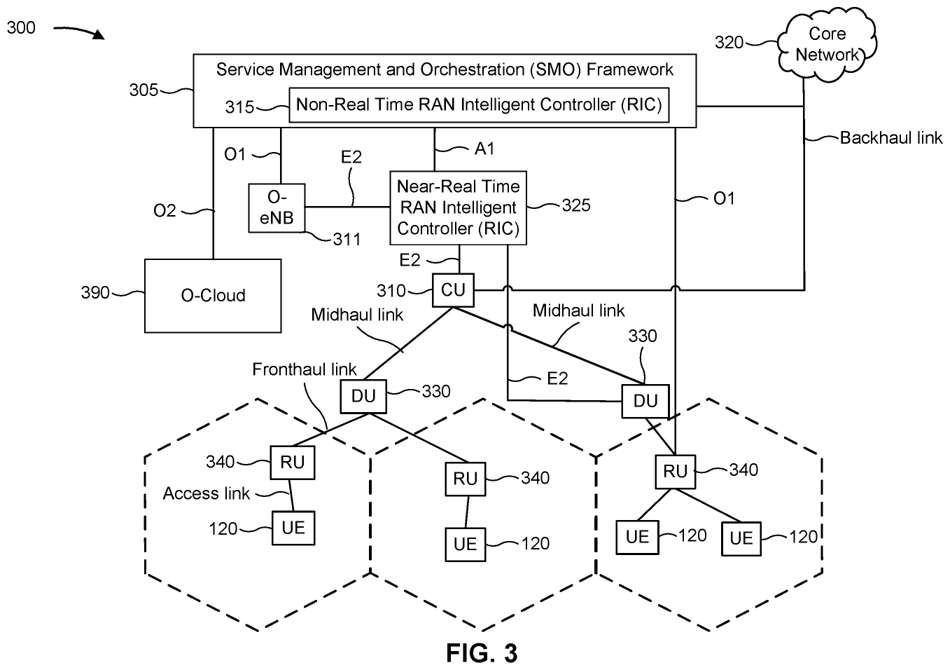

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

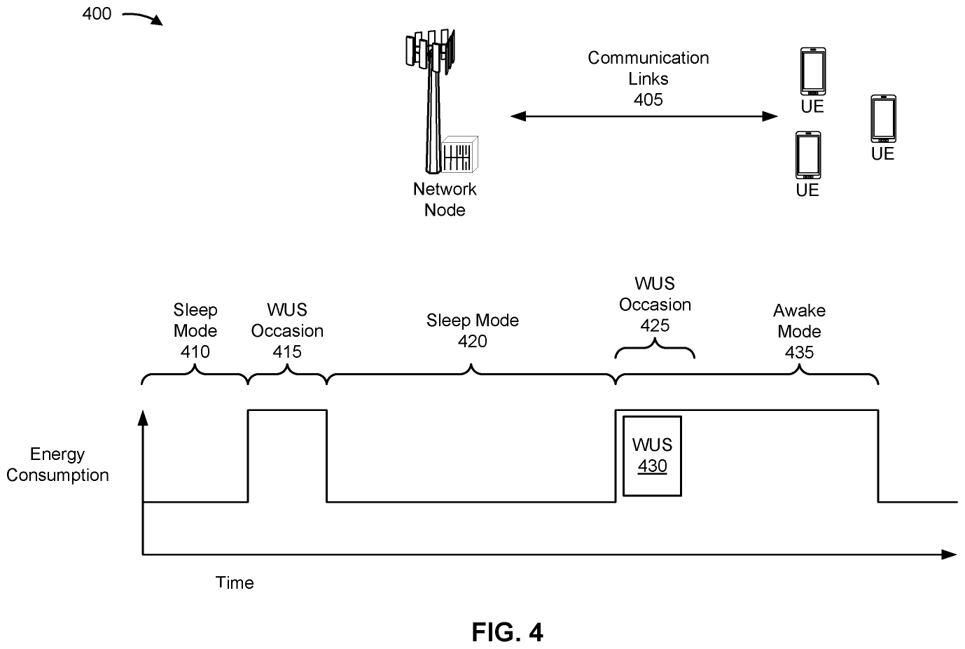

FIG. 4 is a diagram illustrating an example 400 of a network energy saving mode, in accordance with the present disclosure. As shown in FIG. 4, a network node may communicate with multiple UEs via a wireless network. In some examples, the network node may support a cell of a wireless network to which the UEs are connected for wireless communication. As shown in FIG. 4, the network node may establish communication links 405 with the multiple UEs.

The network node may enter an energy saving mode (e.g., a power saving mode, a needs-based communication mode, and/or a discontinuous reception mode, among other examples). The energy saving mode may be selected from a set of available energy saving modes that are configured to conserve power at the network node while supporting network operation. Different energy saving modes may be associated with different power consumption and/or different transition times (e.g., an amount of time to switch between a sleep mode and an awake mode). In some networks, the network node may enter a sleep mode based at least in part on traffic conditions. For example, the network node may enter the sleep mode based at least in part on an amount of traffic and/or a periodicity of traffic satisfying a threshold.

As shown in FIG. 4, the network node may conserve energy by entering a sleep mode 410 when not receiving traffic. However, to maintain awareness of whether one or more linked UEs need to enter a connected state or perform a small data transfer (SDT), the network node may configure WUS occasions. During the WUS occasions, the network node awakens to monitor for WUSs from the one or more linked UEs.

As shown in FIG. 4, the network node does not receive a WUS during a WUS occasion 415. Based at least in part on not receiving a WUS during the WUS occasion 415, the network node returns to sleep mode 420 until a subsequent WUS occasion 425. During the WUS occasion 425, the network node receives a WUS 430 and remains in an awake mode 435 until completing communications with a UE associated with the WUS 430. In the example 400, if any of the multiple UEs have data buffered for transmission to the network node, at least one of the multiple UEs will transmit a WUS during a WUS occasion.

As indicated above, FIG. 4 is provided as an example. Other examples may differ from what is described with regard to FIG. 4.

In some aspects described herein, a UE may transmit an SSB (e.g., an on-demand SSB) using a resource that is offset from a reference resource based at least in part on transmitting a WUS that indicates a request for an SSB. In some examples, a network node may transmit the SSB using a resource (e.g., in time and frequency) that is based at least in part on a configured time and frequency. For example, a timing of the resource may be based at least in part on an offset from a beginning of an active cycle during which a UE transmitted the WUS. In some aspects, a periodicity of on-demand SSBs may be fixed or signaled in a MIB or SIB (e.g., with large, legacy SSB periodicity), or RRC configured before the network node enters a sleep mode.

The network node may transmit a burst of SSB blocks (each on a different beam), where a first SSB is transmitted X units of time after a beginning of an active cycle during which a cell WUS requesting the SSB is received. The UE may monitor for the SSB starting in a window of time that begins at X units of time after the beginning of an active cycle. In some aspects, the network node may choose to transmit the SSB in a proper subset of beams, where some SSB blocks may be skipped by network node (e.g., any SSB block may be skipped, including the first SSB after X units of time). A frequency domain location of the SSB may also be predetermined. For example, a new sync raster (e.g., configured by the network node or defined in a communication protocol) for on-demand SSBs may be defined such that the UE searches for the on-demand SSB in the defined sync raster.

In some aspects, the network node may transmit the SSB using a resource that is offset (e.g., in time and/or frequency) from a legacy SSB resource. In some aspects, a periodicity of on-demand SSBs may be fixed or signaled in a MIB or SIB (e.g., with large, legacy SSB periodicity), or RRC configured before the network node enters a sleep mode. Time and frequency components of the resource used to transmit the SSB (e.g., an on-demand SSB) may be determined by an X time offset and a Y frequency offset from the legacy SSB (e.g., full SSB or light SSB), which may be transmitted with a fixed relatively high periodicity. The UE may begin monitoring for the SSB after transmitting the cell WUS requesting an SSB by Z units of time, where Z is configured or fixed and is defined in units of seconds, a number of slots, or a number of subframes, among other examples. In some aspects, the network node may acknowledge the request for the SSB in a random access response (RAR)-like window. The UE may begin monitoring for the SSB after Z units of time. In some aspects, the cell WUS response may indicate the value of Z to the UE.

In some aspects, the network node may transmit the SSB using a resource that is offset from a cell WUS occasion used to transmit the WUS. For example, the SSB may occupy a resource that is offset in time and/or frequency from a resource allocated for transmission of the WUS. In some aspects, a periodicity of on-demand SSBs may be fixed or signaled in a MIB or SIB (e.g., with large, legacy SSB periodicity), or RRC configured before the network node enters a sleep mode.

Time and frequency components of the resource used to transmit the SSB (e.g., an on-demand SSB) may be determined by an X time offset and a Y frequency offset from the cell WUS occasion that carried the on-demand SSB request (or a last cell WUS occasion, where the UE is repeating the request on multiple occasions). In some aspects, the network node may acknowledge reception of the request for the SSB. In some aspects, the resource being based at least in part on the cell WUS occasion may improve latency as the network node may serve UEs requesting SSBs more quickly.

In some aspects, the network node may support multiple offsets and/or multiple reference resources. In this case, the network may indicate which configuration is used. Alternatively, the UE may indicate which configuration to use. For example, the UE may indicate a requested configuration via content of the cell WUS, a cell WUS occasion used to transmit the cell WUS (e.g., the cell WUS occasion being associated with a configuration), and/or via a cell WUS sequence group or a preamble group used for the cell WUS (e.g., used for scrambling the cell WUS).

Based at least in part on using an offset and/or reference resource that is configured by the network node, no additional signaling may be needed while the network node is in a power saving mode. Based at least in part on using an offset and/or a reference resource that is requested by the UE, the UE may indicate a selection of candidate configurations (e.g., as described herein) that satisfy a need for the SSB (e.g., with reduced latency or with reduced overhead, among other examples).

In some aspects, the network node may transmit the SSB with a power level (e.g., associated with β-PSS) that is configured (e.g., via RRC) by the network node or broadcast to the UE (e.g., in a SIB). In some aspects, the power level may be indicated implicitly using an offset from a β-PSS of a legacy SSB (e.g., a full SSB or a light SSB that is not requested by the UE).

Based at least in part on using a resource for transmission of the SSB that is offset from a reference resource (e.g., with the reference resource known to the UE and the network node), the described techniques can be used to support synchronization of selection of the resource by the UE and the network node for the SSB. In this way, the UE may request and receive the SSB with reduced latency and/or with reduced overhead that may have otherwise been used to schedule the resource explicitly. Additionally, or alternatively, the UE may improve a likelihood of receiving the SSB based at least in part on being synchronized with the network node for selection of the resource. The SSBs may then be used for timing synchronization and/or beam management procedures.

FIG. 5 is a diagram of an example 500 associated with requested SSBs, in accordance with the present disclosure. As shown in FIG. 5, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 5.

As shown by reference number 505, the network node may transmit, and the UE may receive, configuration information. In some aspects, the UE may receive the configuration information via one or more of RRC signaling, one or more medium access control (MAC) control elements (CEs), and/or downlink control information (DCI), among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate to the UE a configuration for selection of a resource for receiving an SSB requested using a WUS (e.g., an on-demand SSB). In some aspects, the indication of the configuration may indicate a reference resource and/or an offset from the reference resource, which the UE may use to identify the resource for receiving the SSB requested using the WUS. In some aspects, the configuration information may indicate one or more candidate parameters (e.g., an offset and/or a reference resource) that may be selected via a later communication for identifying the resource.

The UE may configure itself based at least in part on the configuration information. In some aspects, the UE may be configured to perform one or more operations described herein based at least in part on the configuration information.

As shown by reference number 510, the UE may transmit, and the network node may receive, an indication of a configuration for requesting an SSB and/or receiving the SSB. For example, the UE may indicate a requested configuration for the network node to select for the UE to transmit a request for an SSB using a WUS when the network node is in a power saving mode (e.g., a sleep mode). Additionally, or alternatively, the UE may indicate a requested configuration for the network node to select a resource to transmit the SSB. In some aspects, the UE may indicate a requested reference resource (e.g., a type of resource used as the reference resource) and/or a time and/or frequency offset from the reference resource to use for transmitting the SSB.

As shown by reference number 515, the UE may receive, and the network node may transmit, an indication of the configuration for requesting the SSB and/or for the UE to receive the SSB. In some aspects, the network node may transmit the indication of the configuration based at least in part on receiving a request from the UE for the configuration. In some aspects, the network node may transmit the indication of the configuration independently from (e.g., in the absence of) receiving the indication of the configuration from the UE.

As shown by reference number 520, the UE may receive, and the network node may transmit, an indication of a configuration for a network node sleep mode. In some aspects, the configuration for the network node sleep mode may indicate resources associated with transmission of a cell WUS. For example, the network node may transmit an indication of a frequency channel to use for transmitting the cell WUS and/or a periodicity for transmitting the cell WUS. In some aspects, the network node may transmit the indication of the configuration for the network node sleep mode along with (e.g., in a same message as, or appended to) the indication of the configuration for requesting the SSB and/or receiving the SSB.

As shown by reference number 525, the UE may receive, and the network node may transmit, an indication that the network node initiates a sleep mode. In some aspects, the network node may transmit the indication via a broadcast message and/or a unicast message. In some aspects, the indication that the network node initiates the sleep mode may be transmitted along with the configuration of the network node sleep mode and/or the indication of the configuration for requesting the SSB and/or receiving the SSB.

As shown by reference number 530, the UE may transmit, and the network node may receive, a cell WUS that indicates a request for an SSB. In some aspects, the cell WUS may indicate one or more parameters requested for transmission of the SSB. For example, the cell WUS may indicate the configuration for receiving the SSB (e.g., as discussed in connection with reference number 510).

As shown by reference number 535, the UE may identify a resource associated with receiving the SSB. For example, the UE may identify the resource based at least in part on a configuration of a reference resource and/or an offset from the reference resource. In some aspects, the UE may identify the resource associated with receiving the SSB based at least in part on identifying the reference resource and adding the offset (e.g., in time and/or frequency) to the reference resource.

In some aspects, the reference resource may be associated with a power-saving SSB (e.g., a light SSB) having a periodicity that is associated with reduced power consumption at the network node. In some aspects, the reference resource and/or the offset may be associated with a response to the WUS. For example, the response may indicate an offset from a reference signal and/or may be transmitted on the reference resource.

In some aspects, the resource is an occasion of a periodic resource for receiving a requested SSB (e.g., requested via a WUS). In some aspects, a periodicity of the periodic resource is based at least in part on a communication protocol, a MIB, a SIB, and/or an RRC message received before a receiving network node enters a sleep mode, among other examples. In some aspects, the offset and/or the reference resource is based at least in part on a communication protocol, a MIB, a SIB, an RRC message received before a receiving network node enters a sleep mode, and/or an indication from the UE, among other examples. In some aspects, the indication from the UE may be based at least in part on an indicator within the cell WUS (e.g., an explicit indication), a cell WUS occasion used to transmit the cell WUS (e.g., using a particular cell WUS occasion that is associated with the offset and/or the reference resource), a cell WUS sequence group used for the cell WUS, and/or a cell WUS preamble group used for the cell WUS, among other examples.

In some aspects, the resource may have a frequency component that is based at least in part on a synchronization raster. In some aspects, the synchronization raster may be indicated via a communication protocol, a MIB, a SIB, and/or an RRC message received before a receiving network node enters a sleep mode, among other examples.

As shown by reference number 540, the UE may monitor the resource associated with receiving the SSB. In some aspects, the UE may monitor the resource as identified in connection with reference number 535. In some aspects, the UE may begin monitoring for the SSB at a start time that is associated with a minimum offset from the reference resource. In some aspects, the UE may monitor for the SSB based at least in part on receiving a response associated with the cell WUS.

As shown by reference number 545, the UE may receive, and the network node may transmit, the SSB that is transmitted using the resource that is offset from the reference resource. In some aspects, the network node may transmit a PSS of the SSB with a transmission power that is different from a configured transmission power of a PSS of a legacy SSB that is not requested. In some aspects, the transmission power of the PSS of the SSB may be based at least in part on a SIB, an RRC message received before a receiving network node enters a sleep mode, and/or an offset from the configured transmission power of the PSS of the legacy SSB that is not requested, among other examples.

Based at least in part on using a resource for transmission of the SSB that is offset from a reference resource (e.g., with the reference resource known to the UE and the network node), the UE and the network node may be synchronized in selection of the resource for communication of the SSB. In this way, the UE may request and receive the SSB with reduced latency and/or with reduced overhead that may have otherwise been used to schedule the resource explicitly. Additionally, or alternatively, the UE may improve a likelihood of receiving the SSB based at least in part on being synchronized with the network node for selection of the resource.

As indicated above, FIG. 5 is provided as an example. Other examples may differ from what is described with respect to FIG. 5.

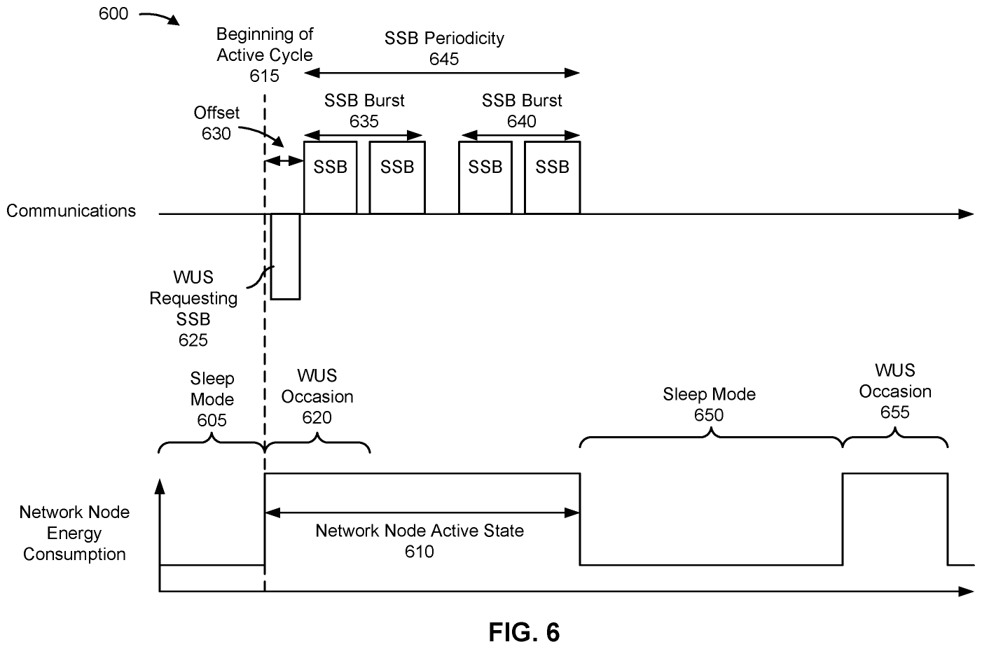

FIG. 6 is a diagram illustrating an example 600 of a network energy saving mode, in accordance with the present disclosure. As shown in FIG. 6, a network node may communicate with a UE via a wireless network. In some examples, the network node may support a cell of a wireless network (e.g., network 100) to which the UE is connected for wireless communication. As shown in FIG. 6, the wireless network may support a network sleep mode and/or a cell WUS to wake up the network node.

As shown in FIG. 6, the network node may conserve energy by entering a sleep mode 605 when not receiving traffic. At a periodic resource, the network node may initiate a network node active state 610 at a beginning of an active cycle 615. Near a beginning of the active cycle 615, the network node may support a WUS occasion 620 during which a UE may request that the network node wake up.

As shown in FIG. 6, a UE may transmit a WUS requesting an SSB burst 625 during the WUS occasion 620. In some aspects, the WUS may request the SSB burst 625 using an explicit indication (e.g., an indicator within the WUS) or an implicit indication (e.g., a resource, such as a WUS occasion or an active cycle used to transmit the WUS or a scrambling applied to the WUS), among other examples.

After an offset from the beginning of the active cycle 615, the network node may transmit an SSB burst 625 that includes one or more SSBs transmitted in a set of SSB resources. The network node may transmit SSBs of the SSB burst 625 using different beams. The network node may then transmit an additional SSB burst 640 that includes one or more SSBs. The SSB burst 635 may be offset from the SSB burst 630 in time and/or may use different beams than SSBs of the SSB burst 630.

In some aspects, a collective set of SSB bursts may have an SSB periodicity 645, after which the network node may initiate the sleep mode 650. The network node may wake up to monitor subsequent WUS occasions 655.

As indicated above, FIG. 6 is provided as an example. Other examples may differ from what is described with respect to FIG. 6.

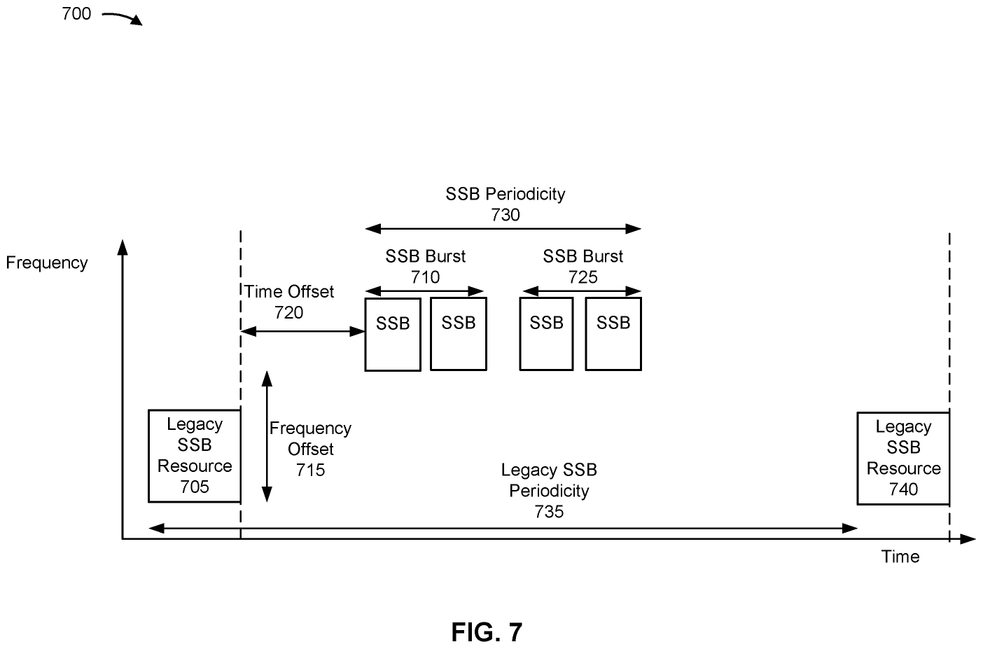

FIG. 7 is a diagram illustrating an example 700 of a network energy saving mode, in accordance with the present disclosure. As shown in FIG. 7, a network node may communicate with a UE via a wireless network. In some examples, the network node may support a cell of a wireless network (e.g., network 100) to which the UE is connected for wireless communication. As shown in FIG. 7, the wireless network may support a network sleep mode and/or a cell WUS to wake up the network node.

As shown in FIG. 7, the network node may configure a periodic legacy SSB resource 705 (e.g., for periodic transmission of a full SSB and/or a light SSB). The periodic legacy SSB resource 705 includes a resource in a time domain and a resource in a frequency domain.

In some aspects, the network node may transmit an SSB burst 710 at a frequency offset 715 and/or at a time offset 720 from the legacy SSB resource 705. In this case, the legacy SSB resource 705 and/or a transmission of an associated legacy SSB may be a reference resource from which the SSB burst 710 (e.g., an on-demand and/or requested SSB) is offset. The network node may then transmit an additional SSB burst 725 that includes one or more SSBs. The SSB burst 725 may be offset from the SSB burst 710 in time and/or may use different beams than SSBs of the SSB burst 710.

In some aspects, a collective set of SSB bursts may have an SSB periodicity 730, after which the network node may initiate the sleep mode. The network node may transmit the legacy SSBs with a legacy SSB periodicity 735, which may result in the network node transmitting a legacy SSB using a legacy SSB resource 740.

As indicated above, FIG. 7 is provided as an example. Other examples may differ from what is described with respect to FIG. 7.

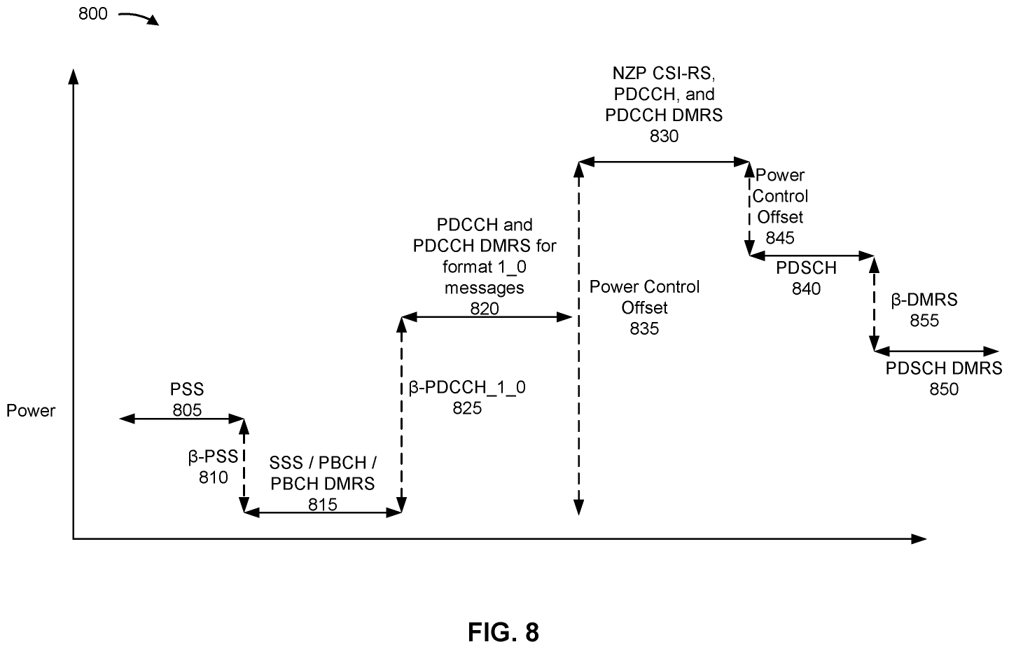

FIG. 8 is a diagram illustrating an example 800 of a network energy saving mode, in accordance with the present disclosure. As shown in FIG. 8, a network node may communicate with a UE via a wireless network. In some examples, the network node may support a cell of a wireless network (e.g., network 100) to which the UE is connected for wireless communication. As shown in FIG. 8, the wireless network may support a network sleep mode and/or a cell WUS to wake up the network node.

As shown in FIG. 8, the network node may use different power levels for transmission of different signaling. The network node may transmit a PSS 805 using a power level that is β-PSS 810 higher than an SSS/PBCH/PBCH DMRS of a same SSB. In some aspects, the value of β-PSS 810 may be different for a legacy SSB than for a requested SSB, such as the SSBs described in connection with FIGS. 5-7. In some aspects, the value of the β-PSS 810 for the requested SSB (e.g., on-demand SSB) may be RRC configured to the UE or broadcast in a SIB. In some aspects, the value of the β-PSS 810 may be indicated explicitly or relative to a β-PSS 810 of a legacy SSB (e.g., non-requested SSB).

As shown in FIG. 8, other types of signaling may be transmitted with different power levels relative to the SSS/PBCH/PBCH DMRS. For example, a physical downlink control channel (PDCCH) and PDCCH DMRS for format 1_0 messages 820 may be transmitted with an increased power of β-PDCCH_1_0 825. A non-zero-power (NZP) channel state information (CSI) reference signal (RS), PDCCH, and PDCCH DMRS 830 (e.g., not format 1_0 messages) may be transmitted with an increased power of power control offset 835. A physical downlink shared channel (PDSCH) communication may be transmitted with a power that is reduced from the NZP CSI-RS, PDCCH, and PDCCH DMRS by an amount of a power control offset 845. A PDSCH DMRS 850 may be transmitted with a power that is reduced from the PDSCH 840 by an amount of a β-DMRS 855.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with requested SSBs.

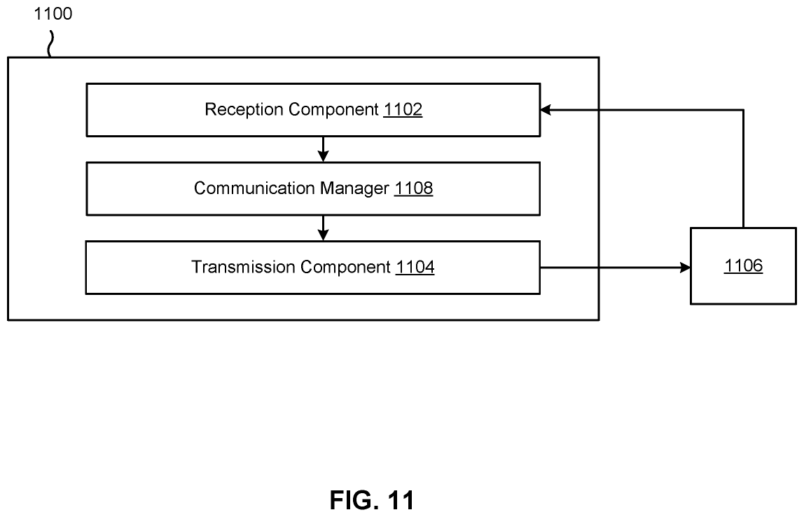

As shown in FIG. 9, in some aspects, process 900 may include transmitting a cell WUS that indicates a request for an SSB (block 910). For example, the UE (e.g., using transmission component 1104 and/or communication manager 1106, depicted in FIG. 11) may transmit a cell WUS that indicates a request for an SSB, as described above.

As further shown in FIG. 9, in some aspects, process 900 may include receiving the SSB via a resource that is based at least in part on an offset from a reference resource (block 920). For example, the UE (e.g., using reception component 1102 and/or communication manager 1106, depicted in FIG. 11) may receive the SSB via a resource that is based at least in part on an offset from a reference resource, as described above.

Process 900 may include additional aspects, such as any single aspect or any combination of aspects described below and/or in connection with one or more other processes described elsewhere herein.

In a first aspect, the reference resource is associated with one or more of an active cycle that is associated with transmission of the cell WUS, or a cell WUS occasion that is associated with transmission of the cell WUS.

In a second aspect, alone or in combination with the first aspect, the reference resource or the offset is associated with one or more of a power-saving SSB having a periodicity that is associated with reduced power consumption at a network node, or a response to the WUS.

In a third aspect, alone or in combination with one or more of the first and second aspects, wherein process 900 includes receiving the SSB during an SSB occasion, and a periodicity of occasions for the SSB is based at least in part on a communication protocol, a master information block, a system information block, or an RRC message received before a receiving network node enters a sleep mode.

In a fourth aspect, alone or in combination with one or more of the first through third aspects, one or more of the offset or the reference resource is based at least in part on one or more of a communication protocol, a master information block, a system information block, an RRC message received before a receiving network node enters a sleep mode, or an indication from the UE.

In a fifth aspect, alone or in combination with one or more of the first through fourth aspects, one or more of the offset or the reference resource is based at least in part on an indication from the UE, and the indication from the UE is based at least in part on one or more of an indicator of the cell WUS, a cell WUS occasion used to transmit the cell WUS, a cell WUS sequence group used for the cell WUS, or a cell WUS preamble group used for the cell WUS.

In a sixth aspect, alone or in combination with one or more of the first through fifth aspects, receiving the SSB comprises one or more of monitoring for the SSB at a time associated with a minimum offset from the reference resource, or monitoring for the SSB based at least in part on receiving a response associated with the cell WUS.

In a seventh aspect, alone or in combination with one or more of the first through sixth aspects, the resource has a frequency component that is based at least in part on a synchronization raster indicated via one or more of a communication protocol, a master information block, a system information block, or an RRC message received before a receiving network node enters a sleep mode.

In an eighth aspect, alone or in combination with one or more of the first through seventh aspects, a transmission power of a PSS of the SSB is different from a configured transmission power of a PSS of a legacy SSB that is not requested.

In a ninth aspect, alone or in combination with one or more of the first through eighth aspects, the transmission power of the PSS is based at least in part on one or more of a system information block, an RRC message received before a receiving network node enters a sleep mode, or an offset from the configured transmission power of the PSS of the legacy SSB that is not requested.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with requested SSBs.

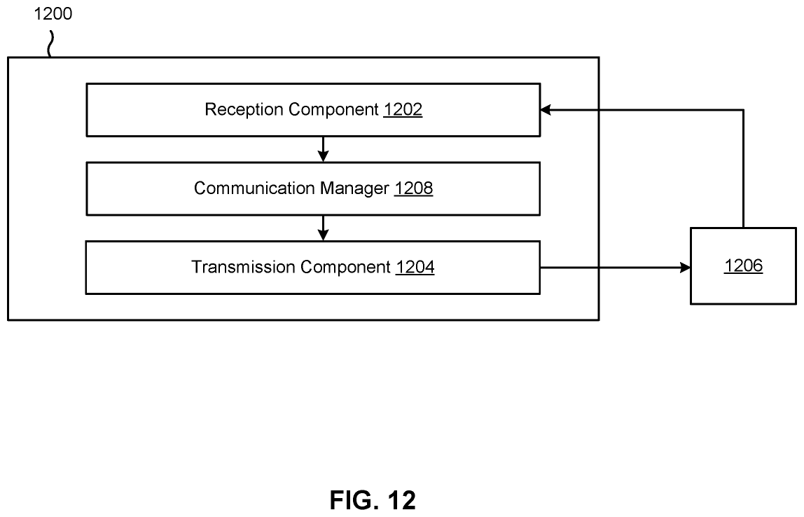

As shown in FIG. 10, in some aspects, process 1000 may include receiving a cell WUS that indicates a request for an SSB (block 1010). For example, the network node (e.g., using reception component 1202 and/or communication manager 1206, depicted in FIG. 12) may receive a cell WUS that indicates a request for an SSB, as described above.

As further shown in FIG. 10, in some aspects, process 1000 may include transmitting the SSB via a resource that is based at least in part on an offset from a reference resource (block 1020). For example, the network node (e.g., using transmission component 1204 and/or communication manager 1206, depicted in FIG. 12) may transmit the SSB via a resource that is based at least in part on an offset from a reference resource, as described above.

Process 1000 may include additional aspects, such as any single aspect or any combination of aspects described below and/or in connection with one or more other processes described elsewhere herein.

In a first aspect, the reference resource is associated with one or more of an active cycle that is associated with reception of the cell WUS, or a cell WUS occasion that is associated with reception of the cell WUS.

In a second aspect, alone or in combination with the first aspect, the reference resource or the offset is associated with one or more of a power-saving SSB having a periodicity that is associated with reduced power consumption at a network node, or a response to the WUS.

In a third aspect, alone or in combination with one or more of the first and second aspects, process 1000 includes transmitting the SSB during an SSB occasion, and a periodicity of occasions for the SSB is based at least in part on a communication protocol, a master information block, a system information block, or an RRC message transmitted before the network node enters a sleep mode.

In a fourth aspect, alone or in combination with one or more of the first through third aspects, one or more of the offset or the reference resource is based at least in part on one or more of a communication protocol, a master information block, a system information block, an RRC message transmitted before the network node enters a sleep mode, or an indication from a UE associated with the cell WUS.

In a fifth aspect, alone or in combination with one or more of the first through fourth aspects, one or more of the offset or the reference resource is based at least in part on an indication from the UE, and the indication from the UE is based at least in part on one or more of an indicator of the cell WUS, a cell WUS occasion used to transmit the cell WUS, a cell WUS sequence group used for the cell WUS, or a cell WUS preamble group used for the cell WUS.

In a sixth aspect, alone or in combination with one or more of the first through fifth aspects, transmitting the SSB comprises one or more of transmitting the SSB at a time associated with a minimum offset from the reference resource, or transmitting the SSB based at least in part on transmitting a response associated with the cell WUS.

In a seventh aspect, alone or in combination with one or more of the first through sixth aspects, the resource has a frequency component that is based at least in part on a synchronization raster indicated via one or more of a communication protocol, a master information block, a system information block, or an RRC message transmitted before the network node enters a sleep mode.

In an eighth aspect, alone or in combination with one or more of the first through seventh aspects, a transmission power of a PSS of the SSB is different from a configured transmission power of a PSS of a legacy SSB that is not requested.

In a ninth aspect, alone or in combination with one or more of the first through eighth aspects, the transmission power of the PSS is based at least in part on one or more of a system information block, an RRC message received before a receiving network node enters a sleep mode, or an offset from the configured transmission power of the PSS of the legacy SSB that is not requested.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a cell WUS that indicates a request for an SSB. The reception component 1102 may receive the SSB via a resource that is based at least in part on an offset from a reference resource.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 5-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a cell WUS that indicates a request for an SSB. The transmission component 1204 may transmit the SSB via a resource that is based at least in part on an offset from a reference resource.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: transmitting a cell wake-up signal (WUS) that indicates a request for a synchronization signal block (SSB); and receiving the SSB via a resource that is based at least in part on an offset from a reference resource.

Aspect 2: The method of Aspect 1, wherein the reference resource is associated with one or more of: an active cycle that is associated with transmission of the cell WUS, or a cell WUS occasion that is associated with transmission of the cell WUS.

Aspect 3: The method of any of Aspects 1-2, wherein the reference resource or the offset is associated with one or more of: a power-saving SSB having a periodicity that is associated with reduced power consumption at a network node, or a response to the WUS.

Aspect 4: The method of any of Aspects 1-3, wherein receiving the SSB comprises receiving the SSB during an SSB occasion, and wherein a periodicity of occasions for the SSB is based at least in part on one or more of: a communication protocol, a master information block, a system information block, or a radio resource control (RRC) message received before a receiving network node enters a sleep mode.

Aspect 5: The method of any of Aspects 1-4, wherein one or more of the offset or the reference resource is based at least in part on one or more of: a communication protocol, a master information block, a system information block, a radio resource control (RRC) message received before a receiving network node enters a sleep mode, or an indication from the UE.

Aspect 6: The method of any of Aspects 1-5, wherein one or more of the offset or the reference resource is based at least in part on an indication from the UE, and wherein the indication from the UE is based at least in part on one or more of: an indicator of the cell WUS, a cell WUS occasion used to transmit the cell WUS, a cell WUS sequence group used for the cell WUS, or a cell WUS preamble group used for the cell WUS.

Aspect 7: The method of any of Aspects 1-6, wherein receiving the SSB comprises one or more of: monitoring for the SSB at a time associated with a minimum offset from the reference resource, or monitoring for the SSB based at least in part on receiving a response associated with the cell WUS.

Aspect 8: The method of any of Aspects 1-7, wherein the resource has a frequency component that is based at least in part on a synchronization raster indicated via one or more of: a communication protocol, a master information block, a system information block, or a radio resource control (RRC) message received before a receiving network node enters a sleep mode.

Aspect 9: The method of any of Aspects 1-8, wherein a transmission power of a primary synchronization signal (PSS) of the SSB is different from a configured transmission power of a PSS of a legacy SSB that is not requested.

Aspect 10: The method of Aspect 9, wherein the transmission power of the PSS is based at least in part on one or more of: a system information block, a radio resource control (RRC) message received before a receiving network node enters a sleep mode, or an offset from the configured transmission power of the PSS of the legacy SSB that is not requested.

Aspect 11: A method of wireless communication performed by a network node, comprising: receiving a cell wake-up signal (WUS) that indicates a request for a synchronization signal block (SSB); and transmitting the SSB via a resource that is based at least in part on an offset from a reference resource.

Aspect 12: The method of Aspect 11, wherein the reference resource is associated with one or more of: an active cycle that is associated with reception of the cell WUS, or a cell WUS occasion that is associated with reception of the cell WUS.

Aspect 13: The method of any of Aspects 11-12, wherein the reference resource or the offset is associated with one or more of: a power-saving SSB having a periodicity that is associated with reduced power consumption at a network node, or a response to the WUS.

Aspect 14: The method of any of Aspects 11-13, wherein transmitting the SSB comprises transmitting the SSB during an SSB occasion, and wherein a periodicity of occasions for the SSB is based at least in part on one or more of: a communication protocol, a master information block, a system information block, or a radio resource control (RRC) message transmitted before the network node enters a sleep mode.

Aspect 15: The method of any of Aspects 11-14, wherein one or more of the offset or the reference resource is based at least in part on one or more of: a communication protocol, a master information block, a system information block, a radio resource control (RRC) message transmitted before the network node enters a sleep mode, or an indication from a user equipment (UE) associated with the cell WUS.

Aspect 16: The method of any of Aspects 11-15, wherein one or more of the offset or the reference resource is based at least in part on an indication from the UE, and wherein the indication from the UE is based at least in part on one or more of: an indicator of the cell WUS, a cell WUS occasion used to transmit the cell WUS, a cell WUS sequence group used for the cell WUS, or a cell WUS preamble group used for the cell WUS.

Aspect 17: The method of any of Aspects 11-16, wherein transmitting the SSB comprises one or more of: transmitting the SSB at a time associated with a minimum offset from the reference resource, or transmitting the SSB based at least in part on transmitting a response associated with the cell WUS.

Aspect 18: The method of any of Aspects 11-17, wherein the resource has a frequency component that is based at least in part on a synchronization raster indicated via one or more of: a communication protocol, a master information block, a system information block, or a radio resource control (RRC) message transmitted before the network node enters a sleep mode.

Aspect 19: The method of any of Aspects 11-18, wherein a transmission power of a primary synchronization signal (PSS) of the SSB is different from a configured transmission power of a PSS of a legacy SSB that is not requested.

Aspect 20: The method of Aspect 19, wherein the transmission power of the PSS is based at least in part on one or more of: a system information block, a radio resource control (RRC) message received before a receiving network node enters a sleep mode, or an offset from the configured transmission power of the PSS of the legacy SSB that is not requested.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
one or more memories; and
one or more processors, coupled to the one or more memories, configured to cause the UE to:
transmit a cell wake-up signal (WUS) that indicates a request for a synchronization signal block (SSB); and
receive the SSB via a resource that is based at least in part on an offset from a reference resource.

2. The UE of claim 1, wherein the reference resource is associated with one or more of:
an active cycle that is associated with transmission of the cell WUS, or
a cell WUS occasion that is associated with transmission of the cell WUS.

3. The UE of claim 1, wherein the reference resource or the offset is associated with one or more of:
a power-saving SSB having a periodicity that is associated with reduced power consumption at a network node, or
a response to the WUS.

4. The UE of claim 1, wherein the one or more processors, to receive the SSB, are configured to cause the UE to receive the SSB during an SSB occasion, and
wherein a periodicity of occasions for the SSB is based at least in part on one or more of:
a communication protocol,
a master information block,
a system information block, or
a radio resource control (RRC) message received before a receiving network node enters a sleep mode.

5. The UE of claim 1, wherein one or more of the offset or the reference resource is based at least in part on one or more of:
a communication protocol,
a master information block,
a system information block,
a radio resource control (RRC) message received before a receiving network node enters a sleep mode, or
an indication from the UE.

6. The UE of claim 1, wherein one or more of the offset or the reference resource is based at least in part on an indication from the UE, and
wherein the indication from the UE is based at least in part on one or more of:
an indicator of the cell WUS,
a cell WUS occasion used to transmit the cell WUS,
a cell WUS sequence group used for the cell WUS, or
a cell WUS preamble group used for the cell WUS.

7. The UE of claim 1, wherein the one or more processors, to receive the SSB, are configured to cause the UE to:
monitor for the SSB at a time associated with a minimum offset from the reference resource, or
monitor for the SSB based at least in part on receiving a response associated with the cell WUS.

8. The UE of claim 1, wherein the resource has a frequency component that is based at least in part on a synchronization raster indicated via one or more of:
a communication protocol,
a master information block,
a system information block, or
a radio resource control (RRC) message received before a receiving network node enters a sleep mode.

9. The UE of claim 1, wherein a transmission power of a primary synchronization signal (PSS) of the SSB is different from a configured transmission power of a PSS of a legacy SSB that is not requested.

10. The UE of claim 9, wherein the transmission power of the PSS is based at least in part on one or more of:
a system information block,
a radio resource control (RRC) message received before a receiving network node enters a sleep mode, or
an offset from the configured transmission power of the PSS of the legacy SSB that is not requested.

11. A network node for wireless communication, comprising:
one or more memories; and
one or more processors, coupled to the one or more memories, configured to cause the network node to:
receive a cell wake-up signal (WUS) that indicates a request for a synchronization signal block (SSB); and
transmit the SSB via a resource that is based at least in part on an offset from a reference resource.

12. The network node of claim 11, wherein the reference resource is associated with one or more of:
an active cycle that is associated with reception of the cell WUS, or
a cell WUS occasion that is associated with reception of the cell WUS.

13. The network node of claim 11, wherein the reference resource or the offset is associated with one or more of:
a power-saving SSB having a periodicity that is associated with reduced power consumption at a network node, or
a response to the WUS.

14. The network node of claim 11, wherein the one or more processors, to transmit the SSB, are configured to cause the network node to transmit the SSB during an SSB occasion, and
wherein a periodicity of occasions for the SSB is based at least in part on one or more of:
a communication protocol,
a master information block,
a system information block, or
a radio resource control (RRC) message transmitted before the network node enters a sleep mode.

15. The network node of claim 11, wherein one or more of the offset or the reference resource is based at least in part on one or more of:
a communication protocol,
a master information block,
a system information block,
a radio resource control (RRC) message transmitted before the network node enters a sleep mode, or
an indication from a user equipment (UE) associated with the cell WUS.

16. The network node of claim 11, wherein one or more of the offset or the reference resource is based at least in part on an indication from the UE, and
wherein the indication from the UE is based at least in part on one or more of:
an indicator of the cell WUS,
a cell WUS occasion used to transmit the cell WUS,
a cell WUS sequence group used for the cell WUS, or
a cell WUS preamble group used for the cell WUS.

17. The network node of claim 11, wherein the one or more processors, to transmit the SSB, are configured to cause the network node to:
transmit the SSB at a time associated with a minimum offset from the reference resource, or
transmit the SSB based at least in part on transmitting a response associated with the cell WUS.

18. The network node of claim 11, wherein the resource has a frequency component that is based at least in part on a synchronization raster indicated via one or more of:
a communication protocol,
a master information block,
a system information block, or
a radio resource control (RRC) message transmitted before the network node enters a sleep mode.

19. The network node of claim 11, wherein a transmission power of a primary synchronization signal (PSS) of the SSB is different from a configured transmission power of a PSS of a legacy SSB that is not requested.

20. The network node of claim 19, wherein the transmission power of the PSS is based at least in part on one or more of:
a system information block,
a radio resource control (RRC) message received before a receiving network node enters a sleep mode, or
an offset from the configured transmission power of the PSS of the legacy SSB that is not requested.

21. A method of wireless communication performed by a user equipment (UE), comprising:
transmitting a cell wake-up signal (WUS) that indicates a request for a synchronization signal block (SSB); and
receiving the SSB via a resource that is based at least in part on an offset from a reference resource.

22. The method of claim 21, wherein the reference resource is associated with one or more of:
an active cycle that is associated with transmission of the cell WUS, or
a cell WUS occasion that is associated with transmission of the cell WUS.

23. The method of claim 21, wherein receiving the SSB comprises receiving the SSB during an SSB occasion, and
wherein one or more of the offset or the reference resource is based at least in part on one or more of:
a communication protocol,
a master information block,
a system information block,
a radio resource control (RRC) message received before a receiving network node enters a sleep mode, or
an indication from the UE.

24. The method of claim 21, wherein one or more of the offset or the reference resource is based at least in part on an indication from the UE, and
wherein the indication from the UE is based at least in part on one or more of:
an indicator of the cell WUS,
a cell WUS occasion used to transmit the cell WUS,
a cell WUS sequence group used for the cell WUS, or
a cell WUS preamble group used for the cell WUS.

25. The method of claim 21, wherein receiving the SSB comprises one or more of:
monitoring for the SSB at a time associated with a minimum offset from the reference resource, or
monitoring for the SSB based at least in part on receiving a response associated with the cell WUS.

26. A method of wireless communication performed by a network node, comprising:
receiving a cell wake-up signal (WUS) that indicates a request for a synchronization signal block (SSB); and
transmitting the SSB via a resource that is based at least in part on an offset from a reference resource.

27. The method of claim 26, wherein the reference resource is associated with one or more of:
an active cycle that is associated with reception of the cell WUS, or
a cell WUS occasion that is associated with reception of the cell WUS.

28. The method of claim 26, wherein transmitting the SSB comprises transmitting the SSB during an SSB occasion, and
wherein one or more of the offset or the reference resource is based at least in part on one or more of:
a communication protocol,
a master information block,
a system information block,
a radio resource control (RRC) message transmitted before the network node enters a sleep mode, or
an indication from a user equipment (UE) associated with the cell WUS.

29. The method of claim 26, wherein one or more of the offset or the reference resource is based at least in part on an indication from the UE, and
wherein the indication from the UE is based at least in part on one or more of:
an indicator of the cell WUS,
a cell WUS occasion used to transmit the cell WUS,
a cell WUS sequence group used for the cell WUS, or
a cell WUS preamble group used for the cell WUS.

30. The method of claim 26, wherein transmitting the SSB comprises one or more of:
transmitting the SSB at a time associated with a minimum offset from the reference resource, or
transmitting the SSB based at least in part on transmitting a response associated with the cell WUS.
